(19) United States
(12) Patent Application Publication
(10) Pub. No.: US 2012/0070293 A1
(43) Pub. Date: Mar. 22, 2012

(54) Wind turbine apparatus, wind turbine system and methods of making and using the same

(76) Inventors: Eric Cwiertnia, Lake Zurich, IL (US); Christopher Stennett, Wauconda, IL (US); Kristofer Klein, Glen Ellyn, IL (US)

(21) Appl. No.: 12/885,001

(22) Filed: Sep. 17, 2010

(51) Int. Cl. F03D 3/00; F03D 11/04; F03D 9/00; F03D 11/00

(52) U.S. Cl. 416/176; 416/243; 416/244 R; 290/55

(57) ABSTRACT

An electricity-generating Savonius-type wind turbine apparatus has a pair of blades configured helically around a central axis. The wind turbine apparatus is modular and sectional such that each section includes a pair of blades useful for being pushed by wind to generate electricity via an attached electrical generator. Further, a series of modular wind turbine sections generates electrically via an attached electrical generator. The wind turbine apparatus further includes one or more airfoils attached to an axis of rotation for aiding in the rotation of the central axis for generating electricity.

### TECHNICAL FIELD

The present invention relates to an electricity-generating wind turbine apparatus and system. Specifically, the present invention relates to a Savonius-type wind turbine apparatus wherein the blades together form a helix around a central axis. The wind turbine apparatus is modular and sectional such that each section is useful for being pushed by wind to generate electricity via an attached electrical generator. The present invention further includes a series of modular wind turbine sections that generate electricity via an attached electrical generator. The wind turbine further includes one or more foils attached to a central axis of rotation. Moreover, methods of making and using the same are provided.

### BACKGROUND

It is, of course, generally known to perform work or to generate power using the energy of wind. For centuries, windmills have been used to turn gears for such uses as grinding grain, such as corn, drawing up and/or pumping water and other like uses. In fact, the region of the Netherlands is known for its windmills for pumping water from low-lying regions. Typically, the rotation of a shaft caused by one or more blades or sails creates annular motion that may be utilized to perform work and, therefore, generate power, such as electrical power.

Modern windmills are known to generate electricity by transforming the annular motion of an axis, caused by rotation of blades or sails, into electrical energy. Specifically, as an axis turns via wind power, the axis steps up via a gear box to an electrical generator. Hence, rotation of the axis of a windmill rotates a shaft in an electrical generator thereby producing electricity.

Windmills, generally, come in two types: horizontal-axis wind turbines (HAWTs) and vertical-axis wind turbines (VAWTs), with HAWTs being the most common. Horizontal-axis wind turbines (HAWT) typically have the main rotor shaft and electrical generator at the top of a tower, and must be pointed into the wind. Small turbines may typically be pointed by a simple wind vane, while large turbines generally use a wind sensor coupled with a servo motor. Most have a gearbox, which turns the relatively slow rotation of the blades into a quicker rotation that is more suitable to drive an electrical generator.

Since a tower produces turbulence behind it, the turbine is usually pointed upwind of the tower. Turbine blades are typically made stiff to prevent the blades from being pushed into the tower by high winds. Additionally, the blades are placed a considerable distance in front of the tower and are sometimes tilted forward into the wind by a small amount.

Downwind machines have been built, despite the problem of turbulence (called “mast wake”), because they don't need an additional mechanism for keeping them in line with the wind, and because in high winds the blades can be allowed to bend which reduces their swept area and thus their wind resistance. Since cyclic (that is repetitive) turbulence may lead to fatigue failures, most HAWTs are upwind machines.

VAWTs are less common, but utilize a vertically-disposed axis that is turned by blades or sails. As with the HAWTs, the VAWTs may perform work, such as generating electricity, via rotation of the axis, which in turn rotates a shaft in an electrical generator, typically by stepping up the speed of the axis rotation. Known VAWTs are Darrieus-type wind turbines, which utilize blades configured as airfoils around a central axis, and operate under the principals of lift and drag as wind flows over the airfoils. The advantage to Darrieus-type wind turbines is that the rotation of the blades are not limited to the speed of the wind flowing thereover, and may reach speeds in excess of the ambient wind speed. Another common VAWT is a Savonius-type wind turbine, which utilizes blades configured in scoops to rotate around a central axis, and are limited to the speed of wind, since Savonius-type wind turbines typically operate solely on the principal of drag caused by the wind.

Most modern wind turbines, however, offer many significant disadvantages. For example, typical HAWTs utilize three or more blades that sit atop large towers. It is difficult to transport the blades and construct these types of wind turbines. For example, many modern wind turbines utilize blades that are up to 45 meters long. It is estimated that transportation of the massive blades accounts for about 20% of the total equipment costs. Moreover, tall HAWTs are difficult to install, needing very tall and expensive cranes and skilled operators. This is due to the fact that these large wind turbines require massive tower construction to support the massive heavy blades, the gearbox and electrical generator. Large wind turbines have also been known to affect side lobes of radar installations, creating signal clutter.

In addition, large wind turbines are unsightly, and because of their size, they can be obtrusively visible across large areas, disrupting the appearing of landscapes. Because of this, there is much opposition to the building of large wind turbines. Still further, large wind turbines utilizing massive blades suffer from fatigue and failure caused by turbulence when a blade passes through the tower's “wind shadow”. To maximize efficiency, large HAWTs typically require a yaw control mechanism to turn the blades toward the wind. Moreover, blades may become coated with ice, especially in colder regions. It is estimated that large wind turbines, such as ones having 45 meter blades, may have tip speeds of up to 300 feet per second. Ice that may break off from blades traveling at such velocities may be propelled away from the blades by centrifugal force, and may cause damage and/or death.

In addition, large wind turbines generate a significant amount of noise that may interfere with individual's enjoyment of the space around the wind turbines. This is especially important in urban areas where there is a high density of people. In addition, large wind turbines, especially those using large blades may be dangerous to wildlife, such as birds. When a large turbine is spinning, wildlife may attempt to traverse through the spaces between the blades. If timed incorrectly, the wildlife may be struck by the spinning blades causing injury and, more likely, death.

Smaller wind turbine designs have been proposed to solve some of these problems. For example, a modern wind turbine design utilizes either a horizontal or, more typically, a vertically disposed axis. On the axis may be one or more blades that are configured in a Savonius curve. In a simple Savonius curve, two blades configured like scoops are disposed facing each other. FIG. 1A illustrates a prior art simple turbine created by two blades in a simple Savonius configuration. FIG. 1B illustrates a sectional view of the simple turbine illustrated in FIG. 1A, and further illustrates how wind causes rotation of a shaft for ultimately driving an electrical generator. Advantageously, Savonius-type wind turbines may operate with wind approaching from, typically, any direction, and need not be rotated into the wind like most HAWTs. Alternatively, the Savonius curve may be more complex in that the two blades, while facing each other, may be configured helically. For example, two blades configured in a helical Savonius configuration form a helix, as illustrated in FIG. 1C. Because the blades are in a helical form, the surface area of the blades in any direction is the same. Specifically, the helical configuration operates to ensure that there is no loss of surface area facing the wind as the blades rotate. In other words, a portion of the surface of the blades will always be perpendicular to the wind direction, no matter from which direction the wind emanates. Therefore, there is a constant force applied to the blades as the blades rotate around the central axis, which is distributed along the length of the blades in a repeating pattern with no loss because of breaks or interruptions in the blades.

Moreover, Savonius-type wind turbines do not suffer from the disadvantages noted above for large wind turbines. For example, a Savonius-type wind turbine does not generate an excessive amount of noise since the blades will spin at only a portion of the wind speed because the Savonius-type blades operate on the drag principle. Moreover, the Savonius-type wind turbines are generally very stable. As the blades turn, there is greater rotational inertia making it more difficult to move the turbine off-axis. Therefore, the load transferred to mounting supports is minimized. In addition, because Savonius-type wind turbines do not generally spin at great speeds, ice will not generally be thrown from the blades. And further, animals see Savonius-type turbines as a solid profile, with no apparent openings, and will not attempt to traverse therethrough.

However, known Savonius-type wind turbines suffer from certain disadvantages. Specifically, known Savonius-type wind turbines typically require large support structures for holding the blades in place. Moreover, known Savonius-type wind turbines are difficult to manufacture in that most typically have large single piece blades that are difficult to move, erect and replace if damaged.

A need, therefore, exists for an apparatus, system and method for producing electrical power from wind energy that is relatively small and easy to transport. Moreover, a need exists for an apparatus, system and method for producing electrical power from wind energy having a size that allows for easy installation without the use of large machinery, such as large cranes and the like.

In addition, a need exists for an apparatus, system and method for producing electrical power from wind energy that has a low profile so that it is not unsightly when in use. Moreover, a need exists for an apparatus, system and method for producing electrical power from wind energy that is relatively small so that it maintains a low profile, especially when disposed on a roof of a building or other similar location.

Further, a need exists for an apparatus, system and method for producing electrical power from wind energy that minimizes turbulence that may lead to stress, fatigue and/or failure when in use. Still further, a need exists for an apparatus, system and method for producing electrical power from wind energy that may harness wind energy from most wind directions.

In addition, a need exists for an apparatus, system and method for producing electrical power from wind energy that may be safer than typical windmills, especially in cold-weather climes, such that ice break-off may be minimized, thereby contributing to safer utilization of the same.

### SUMMARY OF THE INVENTION

The present invention relates to an electricity-generating wind turbine apparatus. Specifically, the present invention relates to a Savonius-type wind turbine apparatus having a pair of blades wherein disposed helically around a central axis. The wind turbine apparatus is modular and sectional such that each section may be pushed by wind to generate electricity via an attached electrical generator. The present invention further includes a series of modular wind turbine sections that generates electricity via an attached electrical generator. The wind turbine further includes one or more airfoils attached to an axis of rotation. Moreover, methods of making and using the same are provided.

To this end, in an embodiment of the present invention, an apparatus is provided. The apparatus comprises: a central axis running from a first end of the wind turbine apparatus to a second end of the wind turbine apparatus; a pair of blades, each of the blades configured in a modified Savonius curve such that the two blades together form a helix around the central axis; a plurality of rods extending from the central axis and connected to the pair of blades in spaced locations to rigidly connect the pair of blades to the central axis; a plurality of airfoils attached to distal ends of the rods; and an electrical generator connected to the central axis, whereby rotation of the pole caused by wind pushing the pair of blades and the plurality of airfoils causes the generation of electricity.

In an embodiment, one of the pair of blades comprises two blade sections connected together.

In an embodiment, the two blade sections are connected together with a midsleeve, wherein the midsleeve comprises slots for receiving ends of the two blade sections.

In an embodiment, the midsleeve comprises at least one hole for receiving a first of the plurality of rods, wherein the first of the plurality of rods rigidly connects the midsleeve connecting the two blade sections to the pole at a distance from the central axis.

In an embodiment, at least one of the blade sections comprises an end sleeve, wherein the end sleeve comprises a slot for receiving an end of the at least one blade section.

In an embodiment, the end sleeve comprises at least one hole for receiving a first of the plurality of rods, wherein the first of the plurality of rods rigidly connects the end sleeve to the central axis at a distance from the central axis.

In an embodiment, the wind turbine apparatus further comprises: a leg mounting hub on the central axis, wherein the leg mounting hub comprises a bearing whereby the central axis freely rotates within the bearing of the leg mounting hub; and a leg attached to the leg mounting hub and further attached to a support structure, whereby the leg supports the wind turbine apparatus allowing the blades and plurality of airfoils to freely rotate when pushed by wind.

In an embodiment, the wind turbine apparatus further comprises: a rod mounting hub rigidly connected to the central axis, wherein a first of the plurality of rods is rigidly connected to the rod mounting hub, wherein the first of the plurality of rods rigidly connects at least one of the pair of blades to the central axis.

In an embodiment, the first of the plurality of rods is further connected at its distal end to one of the plurality of airfoils.

In an embodiment, the wind turbine apparatus further comprises: a first rod mounting hub rigidly connected to the central axis, wherein a first of the plurality of rods is rigidly connected to the first rod mounting hub, wherein the first of the plurality of rods rigidly connects a first of the pair of blades to the central axis; and a second rod mounting hub rigidly connected to the central axis, wherein a second of the plurality of rods is rigidly connected to the second rod mounting hub, wherein the second of the plurality of rods rigidly connects the first of the pair of blades to the central axis.

In an alternate embodiment of the present invention, a wind turbine system is provided. The wind turbine system comprises: a first wind turbine section comprising a first pole running from a first end of the first wind turbine section to a second end of the first wind turbine section and a first pair of blades, each of the blades in the first pair of blades configured in a Savonius curve such that the first pair of blades together form a double helix around the first pole, the first pole forming a central axis for the first wind turbine section, and the second pair of blades rigidly connected to the first pole; a second wind turbine section comprising a second pole running from a first end of the second wind turbine section to a second end of the second wind turbine section and a second pair of blades, each of the second pair of blades configured in a Savonius curve such that the second pair of blades together form a double helix around the second pole, the second pole forming a central axis for the second wind turbine section, and the second pair of blades rigidly connected to the second pole, the second pole of the second wind turbine section connected to the first pole of the first wind turbine section; and an electrical generator attached to at least one of the first pole or the second pole for generating electricity upon rotation of the first and second pairs of blades.

In an embodiment, one of the first pair of blades comprises two blade sections connected together.

In an embodiment, the two blade sections are connected together with a midsleeve, wherein the midsleeve comprises slots for receiving ends of the two blade sections.

In an embodiment, the midsleeve comprises at least one hole for receiving at least one of the plurality of rods, wherein the at least one of the plurality of rods rigidly connects the midsleeve to the pole a distance from the pole.

In an embodiment, at least one of the blade sections comprises an end sleeve, wherein the end sleeve comprises a slot for receiving an end of the at least one blade section.

In an embodiment, the end sleeve comprises at least one hole for receiving at least one rod, wherein the at least one rod rigidly connects the end sleeve to the pole a distance from the first pole.

In an embodiment, the wind turbine system further comprises: a leg mounting hub on the first pole, wherein the leg mounting hub comprises a bearing whereby the first pole freely rotates within the bearing of the leg mounting hub; and at least one leg attached to the leg mounting hub and a support structure, whereby the at least one leg supports the wind turbine apparatus allowing the blades and plurality of airfoils to freely rotate when pushed by wind.

In an embodiment, the wind turbine system further comprises: a plurality of rods extending from the first pole and connected to the first pair of blades in spaced locations to rigidly connect the first pair of blades to the first pole; and a plurality of airfoils attached to distal ends of the rods.

In an embodiment, the wind turbine system further comprises: a rod mounting hub rigidly connected to the first pole, wherein a first of the plurality of rods is rigidly connected to the rod mounting hub, wherein the first of the plurality of rods rigidly connects a first blade of the first pair of blades to the pole.

In an embodiment, the first of the plurality of rods is further connected at its distal end to a first of the plurality of airfoils.

It is, therefore, an advantage of the present invention to provide an apparatus, system and method for producing electrical power from wind energy that is relatively small and easy to transport.

Moreover, it is an advantage of the present invention to provide an apparatus, system and method for producing electrical power from wind energy having a size that allows for easy installation without the use of large machinery, such as large cranes and the like.

In addition, it is an advantage of the present invention to provide an apparatus, system and method for producing electrical power from wind energy that has a low profile so that it is not unsightly when in use.

Moreover, it is an advantage of the present invention to provide an apparatus, system and method for producing electrical power from wind energy that is relatively small so that it maintains a low profile, especially when disposed on a roof of a building or other similar location.

Further, it is an advantage of the present invention to provide an apparatus, system and method for producing electrical power from wind energy that minimizes turbulence that may lead to stress, fatigue and/or failure when in use.

Still further, it is an advantage of the present invention to provide an apparatus, system and method for producing electrical power from wind energy that may harness wind energy from most wind directions.

In addition, it is an advantage of the present invention to provide an apparatus, system and method for producing electrical power from wind energy that may be safer than typical windmills, especially in cold-weather climes, such that ice break-off may be minimized thereby contributing to safer utilization of the same.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A, 1B and 1C illustrate views showing prior art configurations of Savonius-type wind turbine electricity generators.

FIG. 2 illustrates an elevated perspective view of an electrical power-generating apparatus in an embodiment of the present invention.

FIG. 3 illustrates a perspective view of a single section of an electrical power-generating apparatus in an embodiment of the present invention.

FIG. 4 illustrates an elevated, perspective, exploded view of a single section of an electrical power-generating apparatus in an embodiment of the present invention.

FIG. 5 illustrates a perspective view of a leg and an attachment plate in an embodiment of the present invention.

FIG. 6 illustrates a close-up view of a leg mounting block of a wind turbine section in an embodiment of the present invention.

FIG. 7 illustrates a perspective view and close-up views of a midsleeve in an embodiment of the present invention.

FIG. 8 illustrates a perspective view and close up views of a bottom cap sleeve in an embodiment of the present invention.

FIG. 9 illustrates a perspective view and close up views of a top cap sleeve in an embodiment of the present invention.

FIG. 10 illustrates a perspective view of a Savonius-type wind turbine in an alternate embodiment of the present invention.

FIG. 11 illustrates a perspective view of a Savonius-type wind turbine disposed within a high tension wire support structure in an embodiment of the present invention.

FIG. 12 illustrates a perspective view of a Savonius-type wind turbine disposed on a side of a cell-phone tower in an alternate embodiment of the present invention.

### DETAILED DESCRIPTION OF THE PRESENTLY PREFERRED EMBODIMENTS

The present invention relates to an electricity-generating wind turbine apparatus. Specifically, the present invention relates to a Savonius-type wind turbine apparatus having a pair of blades disposed helically around a central axis. The wind turbine apparatus is modular and sectional. The wind turbine apparatus is useful for being pushed by wind to generate electrical power via an attached electrical generator. The present invention further includes a series of modular wind turbine sections that generate electricity via an attached electrical generator. The wind turbine further includes one or more foils attached to an axis of rotation. Moreover, methods of making and using the same are provided.

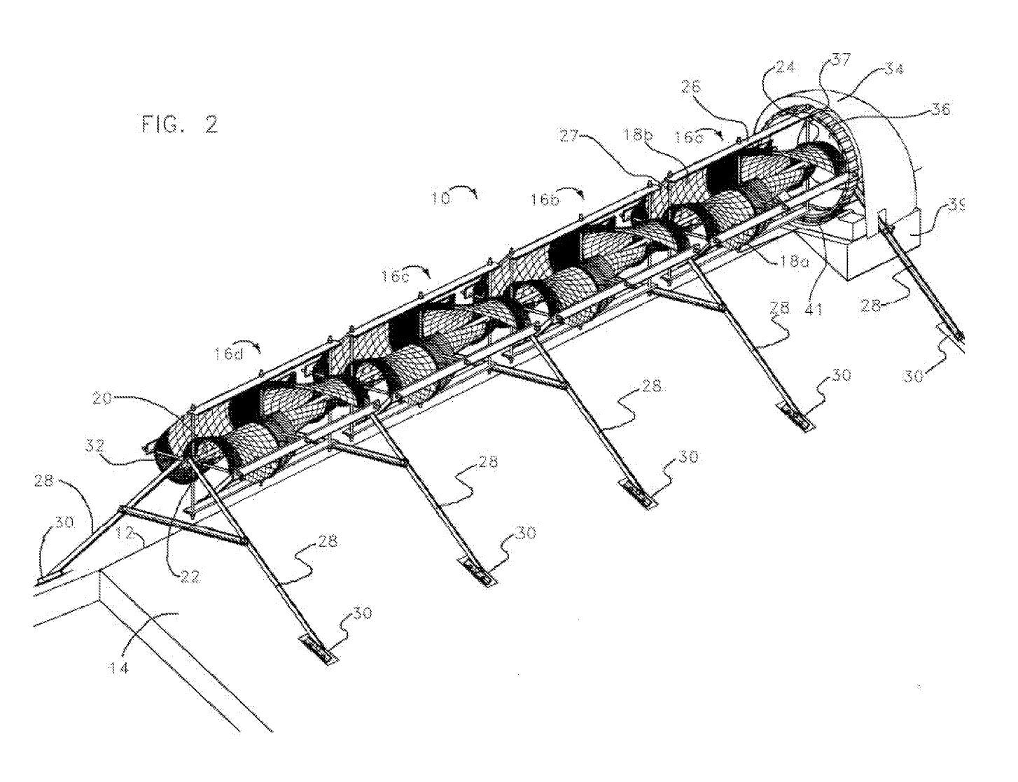

Now referring to the drawings, wherein like numerals refer to like parts, FIG. 2 illustrates a wind turbine apparatus 10 disposed on or near a peak 12 of a roof 14 of a building. Although the present invention is described as being on a roof of a building, the wind turbine apparatus 10 may be disposed in any location whereby the wind turbine apparatus 10 may receive a flow of wind. Specifically, the wind turbine apparatus includes a plurality of wind turbine sections 16a, 16b, 16c and 16d, each interconnected to each other in series. Although the present invention is described as having four wind turbine sections 16a, 16b, 16c, 16d, any number of wind turbine sections may be included. For example, the wind turbine apparatus may simply include a single wind turbine section. Alternatively, the wind turbine apparatus may include more than one wind turbine apparatus connected in series.

Each section 16a, 16b, 16c, 16d comprises two blades 18a, 18b disposed in a modified Savonius curve, such that the two blades 18a, 18b form a helix configuration. For purposes of the present invention, the term “modified Savonius curve” refers to a pair of blades disposed as a Savonius-type wind turbine that are configured helically around a central axis. The most efficient embodiment of the helical configuration has the most surface area presented towards the direction from which the wind emanates. Generally, the degree of rotation may preferably be 90 degrees per unit of measure, which is generally equal to the diameter of the turbine. Therefore, if the diameter of the turbine is about two feet, then for every two feet of length of the blades, the helical configuration should preferably have a degree of rotation of 90 degrees. Another advantage of the helical configuration of the modified Savonius curve is that it is scaleable, in that the proportions may be consistent no matter the size of the turbine. For example, if the diameter of the turbine is about 4 feet, then the degree of rotation of the helical blades should be, preferably, 90 degrees over 4 feet of length of the turbine.

The blades 18a, 18b may be generally lightweight so as to easily be pushed by the wind, yet rigid and resistant to weathering, warping, bending or the like when in use. Specifically, the blades 18a, 18b may be made from metal, such as aluminum, or plastic. Preferably, the blades 18a, 18b are made from thermoplastic and are transparent and/or translucent so as to be less conspicuous when in use, especially on the top of a structure. Moreover, a central axis 20 in, preferably, the form of a pole runs from a first end 22 of the wind turbine apparatus 10 to a second end 24 of the wind turbine apparatus connecting each section 16a-16d in series. The pole may be rigid and made from any material apparent to one of ordinary skill in the art. Preferably, the pole is steel to maintain strength. The blades 18a, 18b are generally disposed helically around the central axis 20.

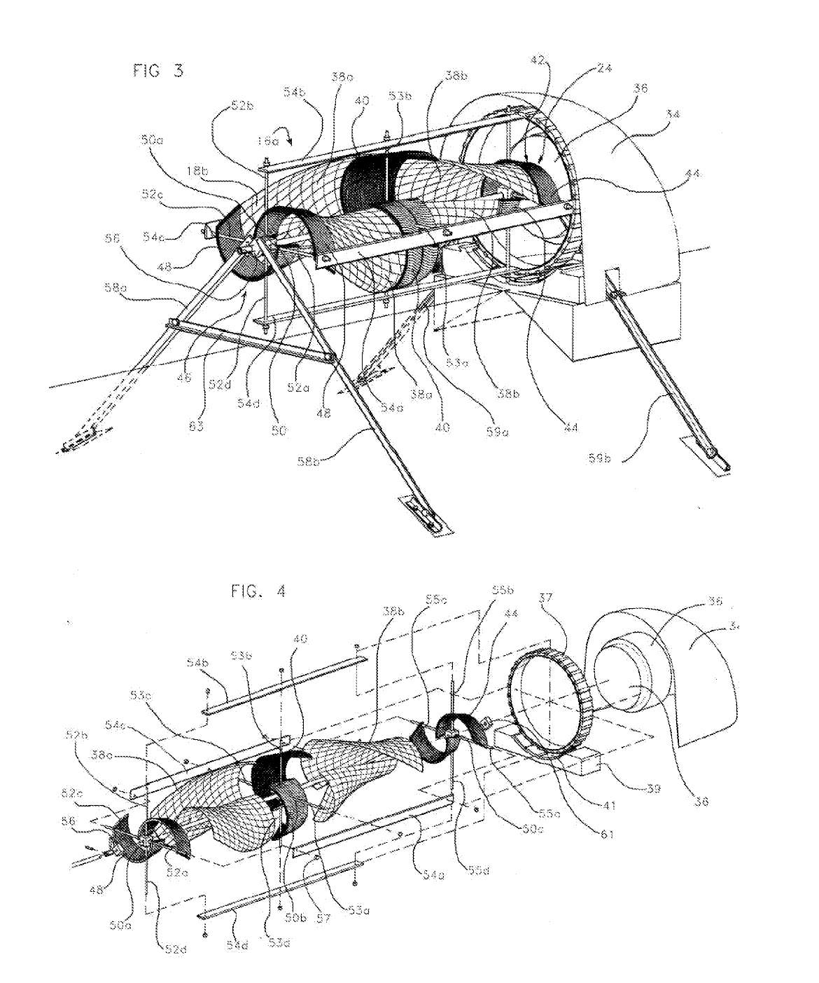

The wind turbine apparatus 10 may include a plurality of foils 26 disposed in spaced location from the central axis 20 and attached to a plurality of rods 27 that are rigidly connected to mounting hubs (as shown in FIG. 3 as reference numeral 50) that are, in turn, connected to the central axis 20, such that rotation of the plurality of foils 26 around the central axis 20 also causes rotation of the central axis 20. Each foil 26 may have a cross-sectional shape of an airfoil, whereby the flow of wind over the airfoil shape may cause each foil 26 to move, thereby moving the central axis 20. The foils 26 are described in more detail below with reference to FIGS. 3 and 4.

The wind turbine apparatus includes a plurality of legs 28 that hold the wind turbine apparatus 10 in position on or near the peak 12 of the roof 14 of the building, or in any other location apparent to one having ordinary skill in the art for being pushed by wind. The legs 28 may be rigidly attached to plates 30 and are described in more detail below with respect to FIG. 5. The legs are attached to blocks 32 having a bearing therein allowing for the rotation of the central axis 20, but not the blocks 32. The central axis 20 may rest within each bearing within each of the blocks 32 and may rotate in relation to each block 32. The legs 28 are described in more detail below with respect to FIGS. 3 and 5.

Disposed on the end 24 of the wind turbine apparatus 10 may be a hood 34 containing an electrical generator 36. In general, rotation of the central axis 20 may cause electrical power generation as known to those of ordinary skill in the art. Step up gears may be utilized to control or otherwise provide for high-speed rotation to maximize the electrical power generation. It should be noted that any electrical generator may be utilized in the present invention as apparent to one having ordinary skill in the art.

Alternatively, or in addition to the electrical generator 36, may be an electrical generator caused by rotation of a loop of magnets 37 disposed around the central axis 20 and attached to rods 27 at or near the airfoils 26, causing rotation of the loop of magnets 37 as the blades 18a, 18b rotate around the central axis 20. A block 39 disposed beneath the loop of magnets 37 may have a plurality of electrical pick-ups 41 for inducing an electrical current to flow as the loop of magnets 37 rotates around the central axis 20 and in proximity to the pick-ups 41. A magnetic flux caused by the movement of the loop of magnets 37 past the pick-ups 41 may cause electrical current to flow.

Any electrical generator apparent to one having ordinary skill in the art is useful for the present invention, when selected in view of the size of the generator, the power output, the speed of rotation for the electrical generator and other like considerations. For example, in preferred embodiments of the present invention, A Moog brand electrical generator AG-12600-B-1ES is preferred, having a generating capacity of 1919 Watts. In addition, a Ginlong generator may be utilized generating 1000 Watts, 1500 Watts or 1800 Watts may be useful for the present invention. It is preferred to maximize the power generation via rotation of the wind turbine, as described herein.

Wind flowing through the wind turbine apparatus 10 may cause the blades 18a, 18b and the foils 26 in each wind turbine section 16a-16d to rotate, thereby causing rotation of the central axis 20, leading to electricity generation in the electrical generator 36 within the hood 34 and/or via electrical induction. As illustrated, the modified Savonius curve of the blades 18a, 18b in each section 16a-16d allows for rotation of the central axis 20 no matter which direction the wind flows therethrough, although most efficient utilization of the wind turbine apparatus 10 may occur when the wind blows at the blades at an angle perpendicular to the axis of rotation of the central axis 20. Moreover, although the wind turbine apparatus 10, as illustrated and described herein, may be utilized in any location that may interact with wind energy, it is preferred that the wind apparatus 10 be located on or near the peak 12 of a roof 14, as illustrated in FIG. 2. The roof profile of a home with a peak, such as on a typical home, allows for the concentration of wind energy at the peak, as the wind is pushed upward towards the peak as the wind interacts with the roof profile. This may allow for more efficient harnessing of wind energy as the wind flows thereover.

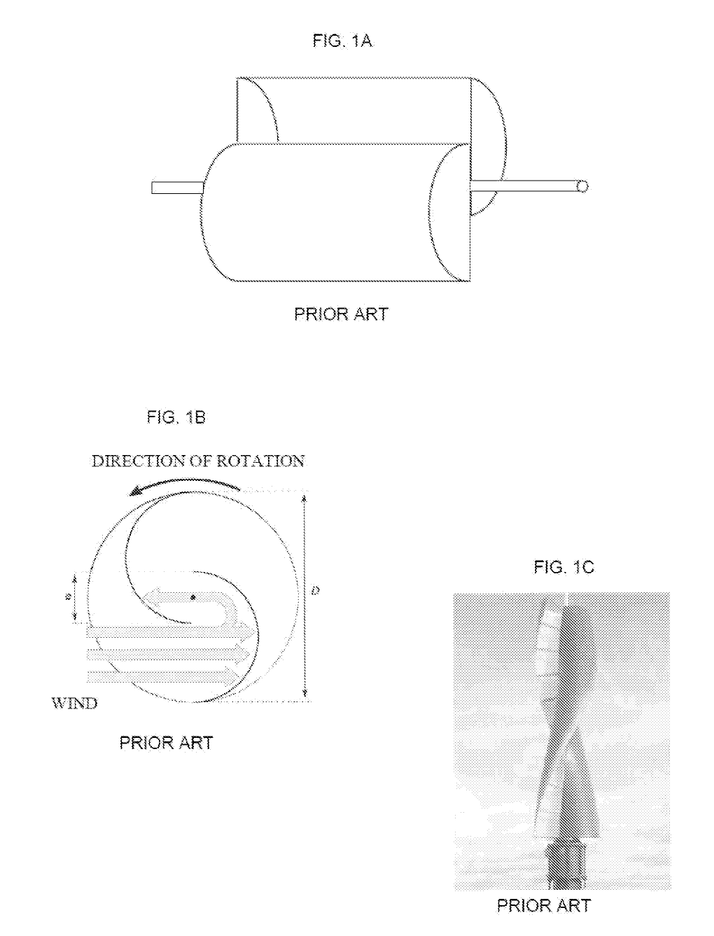

FIG. 3 illustrates a close-up perspective view of a single section 16a of the wind turbine apparatus 10, as illustrated in FIG. 2. Specifically, the section 16a includes the two blades 18a, 18b disposed in the modified Savonius curve, as described above. While the section 16a is shown and described with respect to FIG. 2, it should be noted that the section 16a is generally identical to sections 16b, 16c and 16d, as shown and described with respect to FIG. 1, and contain, generally, identical or similar parts. The only difference between sections 16a, relative to sections 16b-16d, is that section 16a is attached to the hood 34 and the central axis 20 is connected at the end 24 of the wind turbine apparatus 10 to the electrical generator 36 disposed within the hood 34. Each section, 16a-16d is generally identical, and may be attached in series to form the wind turbine apparatus 10, as illustrated in FIG. 1. Therefore, each wind turbine section, as described and illustrated herein, may have either the electrical generator disposed within the hood 34 attached to a side thereof, another wind turbine section attached thereto, or nothing attached thereto (as shown in FIG. 2 with reference to section 16d, where the end 22 of the wind turbine apparatus is shown not attached to any other part, section, portion or material).

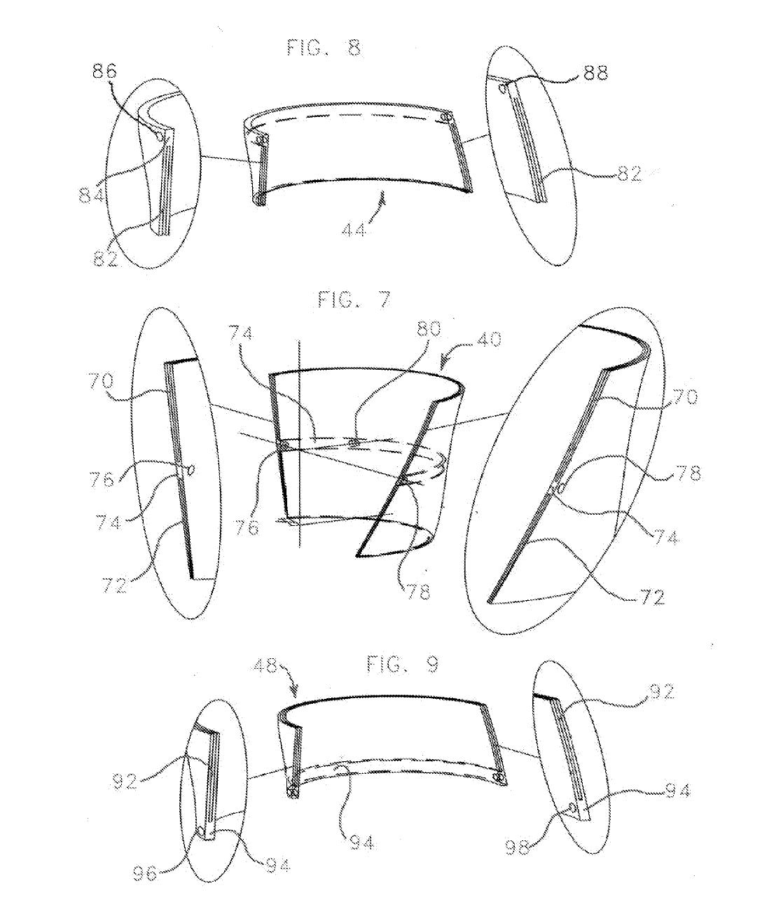

As illustrated in FIG. 3, blades 18a, 18b may each include blade sections 38a, 38b. The blade sections 38a, 38b of the blades 18a, 18b may be interconnected to each other by midsleeve 40 that connects the blade section 38a and the blade section 38b of each of the blades 18a, 18b. The midsleeves 40 of the blades 18a, 18b are illustrated and described in greater detail below with reference to FIG. 7, below. Attached on a first end 42 of each of the blades 18a, 18b may be bottom end sleeves 44. Attached on a second end 46 of each of the blades 18a, 18b may be top end sleeves 48. The bottom end sleeves 44 and the top end sleeves 48 are further shown and described below with reference to FIGS. 8 and 9, respectively.

Still referring to FIG. 3, the section 16a may further have at least one leg mounting hub 56 having legs 58a, 58b (described as legs 28 in FIG. 2) rigidly disposed thereon. Legs 59a, 59b are also shown, and may also be attached to a leg mounting hub (not shown in FIG. 3, but shown as leg mounting hub 61 in FIG. 4). The legs 58a, 58b and 59a, 59b may extend parallel to adjacent respective faces of the leg mounting hubs 56 and 61, and may be rigidly attached to a structure, such as a roof of a building, such as a house, or other structure as apparent to one having ordinary skill in the art, and as illustrated in FIG. 5. Generally, the legs 58a, 58b, and 59a, 59b, may rigidly hold the section 16a in place on the top of a structure, such that wind blowing across the blades 18a, 18b may rotate the blades 18a, 18b and, therefore, the central axis 20, thereby generating electricity in the electrical generator 36. A cross-bar 63 may be disposed between the legs 58a, 58b to aid in rigidly holding legs 58a, 58b and to provide structural support to the legs 58a, 58b. As illustrated in FIG. 1, the other wind turbine sections 16b-16d may each also have legs extending from leg mounting hubs on the central axis 20.

Still referring to FIG. 3 and referring to FIG. 4, an exploded view of the wind turbine section 16a, the central axis 20 may have a plurality of rod mounting hubs 50a, 50b and 50c disposed at various locations along the central axis 20. Preferably, the rod mounting hubs 50a, 50b, 50c may be disposed, respectively, in three spaced-apart locations in each of the wind turbine sections 16a-16d (as illustrated in FIG. 1) on the central axis 20: on or near the end 42 of the blades 18a, 18b, at a midpoint between the ends 42, 46 of the blades 18a, 18b and on or near the end 46 of the blades 18a, 18b. The rod mounting hubs 50a, 50b, 50c may be rigidly connected to the central axis 20, such that the rod mounting hubs 50a, 50b, 50c may rotate the central axis 20 when the rod mounting hubs 50a-50c are rotated by the rotation of the blades 18a, 18b and/or the airfoils 54a-54d, as described in more detail below. Generally, the rod mounting hubs 50a, 50b, 50c may be cubical in shape, such that the central axis 20 runs through two opposing faces of each of the rod mounting hubs 50a, 50b, 50c. Disposed in each face of the rod mounting hubs 50a, 50b, 50c may be four rods, 52a, 52b, 52c, and 52d; 53a, 53b, 53c and 53d; and 55a, 55b, 55c and 55d, as illustrated in FIGS. 3 and 4, whereby the four rods 52a-52d, 53a-53d and 55a-55d, respectively, perpendicularly extend from the remaining four faces of each of the rod mounting hubs 50a, 50b, 50c, respectively. The four rods 52a-52d, 53a-53d, 55a-55d extending outwardly from the rod mounting hubs 50a, 50b, 50c, respectively, may be made from steel or other rigid material as apparent to one having ordinary skill in the art.

As illustrated in FIGS. 3 and 4, the four rods 52a-52d extending from rod mounting hub 50a may further extend through the top end sleeves 48 of each of the blades 18a, 18b. The rods 52a-52d extending from rod mounting hub 50a may be connected on their distal ends to airfoils 54a, 54b, 54c and 54d.

Further, as illustrated in FIGS. 3 and 4, the rods 53a-53d, may be disposed through the midsleeves 40 at midsections of the pair of blades 18a, 18b. Still further, as illustrated in FIGS. 3 and 4, rods 55a-55d may be disposed through bottom end sleeves 44 at the ends 42 of the pair of blades 18a, 18b.

Moreover, the airfoils 54a-54d may further be connected to the four rods 53a-53d extending from rod mounting hub 50b, and further may be connected to the four rods 55a-55d extending from rod mounting hub 50c. The airfoils 54a-54d may have an airfoil profile, such as a teardrop profile, such that wind that may flow over the airfoils 54a-54d may cause lift on the airfoils, thereby translating to rotational movement of the airfoils 54a-54d, thereby providing further rotation to the central axis 20 and, therefore, may aid in the generation of electricity at the electrical generator 36 and/or via electrical induction. The rods 52a-52d, 53a-53d, and 55a-55d may also help to stabilize the wind turbine apparatus 10 by rigidly holding the blades 18a, 18b and the airfoils 54a-54d in place at the various locations along the wind turbine section 16a.

As illustrated in FIGS. 3 and 4, the rods 52a-52d may be disposed through the top end sleeve 48 to rigidly hold the top end sleeve 48 in place and, thereby, rigidly holding the blades 18a, 18b in place at the end 46 of the blades 18a, 18b. Disposed on each distal end of the rods 52a-52d, 53a-53d and 55a-55d may be a locking nut 57 to hold each of the airfoils 54a-54d in place on each of the distal ends of the rods 52a-52d, 53a-53d and 55a-55d, respectively.

As noted above, FIG. 4 illustrates an exploded view of the wind turbine section 16a, as shown and described above with reference to FIG. 3, but without supporting legs. As illustrated in FIG. 4, the blades 18a, 18b, each having blade sections 38a, 38b rigidly disposed together via midsleeves 40, may be rigidly attached to the rods by bottom and top end sleeves 44, 48, respectively. It should be noted, however, that although FIG. 4 illustrates the blade sections 38a, 38b, the bottom end sleeves 40, the midsleeves 44 and the top end sleeves 48, respectively, the rods 52a-52d, 53a-53d, and 55a-55d, and the airfoils 54a-54d, the mounting legs 58a, 58b and 59a, 59b are not illustrated, for purposes of maintaining clarity in the exploded view of the parts that are shown.

Referring now to FIG. 5, leg 58b is illustrated, and may be attached to a mounting plate 60 via flange 62. Flange 62 may be L-shaped in profile such that the leg 58b may be bolted to the flange 62 via a bolt 64, yet adjustable based on the pitch of the mounting plate 60 on a structure, such as on a roof of a building such as a house. A plurality of legs similar if not identical to leg 58b may be provided at various locations on the wind turbine apparatus 10 to rigidly hold the wind turbine apparatus 10 in place when disposed on a structure. The legs 58a, 58b, and 59a, 59b as well as the other legs along wind turbine sections 16b-16d, may help the wind turbine apparatus 10 to be disposed above the structure with a space thereunder, such that the blades 18a, 18b, and the airfoils 54a-54d of the wind turbine section 16a, and the equivalent elements on wind turbine sections 16b-16d, may freely rotate without hitting the structure on which the wind turbine apparatus 10 is mounted.

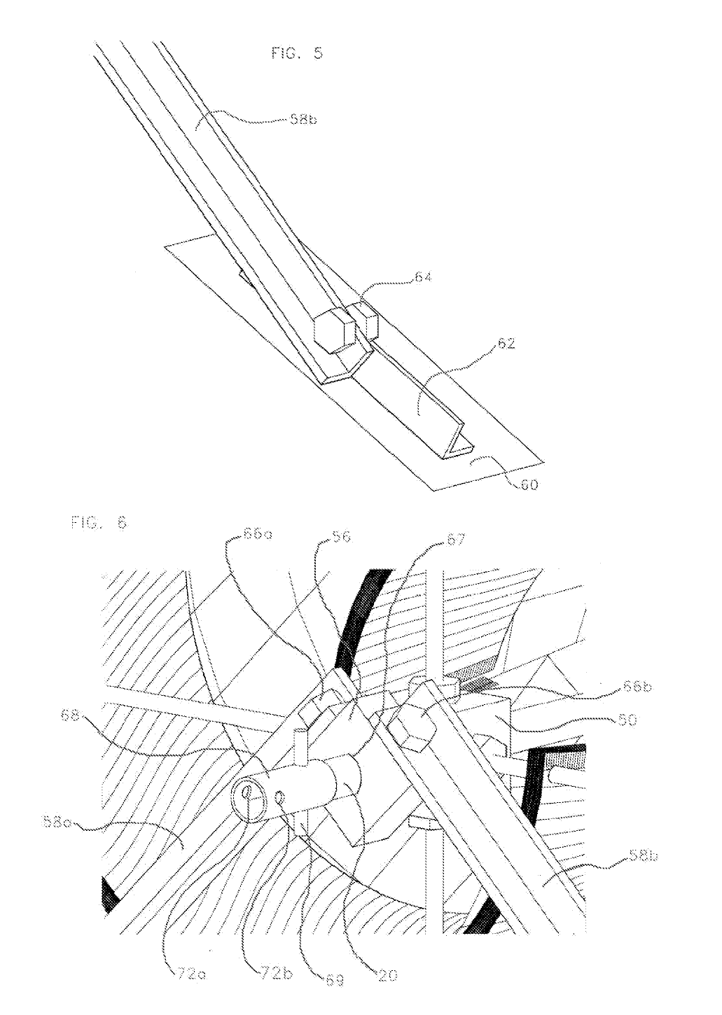

FIG. 6 illustrates a close-up perspective view of a leg mounting hub 56 disposed on central axis 20 in an embodiment of the present invention. The leg mounting hub 56 may be generally cubical in shape and the legs 58a, 58b may be bolted thereto via bolts 66a, 66b. The leg mounting hub 56 may have a bore 67 and bearing (not shown) disposed within the bore 67 so that the central axis 20 may freely rotate therein without rotation of the leg mounting hub 56.

The central axis 20 may have a connector sleeve 68 disposed on an end thereof having a pin 69 disposed therethrough for holding the connector sleeve 68 to the central axis 20. As illustrated, a pole forming a central axis of an adjacent wind turbine section (not shown) may be disposed within the connector sleeve 68, and a pin (not shown), such as a cotter pin, for example, may be disposed through holes 72a, 72b to hold the pole of the adjacent wind turbine section. Therefore, additional wind turbine sections, such as wind turbine sections 16b-16d, may be attached serially to the wind turbine section 16a. Each of the adjacent wind turbine sections may have identical or similar elements, thereby allowing still further wind turbine sections to attach thereto.

Referring now to FIG. 7, a midsleeve 40 is illustrated. The midsleeve 40, as described above for disposing on each of the blades 18a, 18b to generally operate as a linkage between, for example, the blade sections 38a, 38b. Each midsleeve 40 includes slots 70, 72 disposed on opposite ends of the midsleeve 40 for holding edges of the blade sections 38a, 38b. Specifically, ends of the blade sections 38a, 38b may be disposed within the slots 70, 72, thereby holding the ends of the blade sections 38a, 38b together, with the midsleeve 40 forming the linkage therebetween. A solid section 74 may be disposed between the slots 70, 72 and running the length of the midsleeve 40 for separating the slots 70, 72 from each other. Holes 76, 78 may be disposed on opposite edges of the midsleeve 40, and may be disposed to receive rods 53b, 53d extending from rod mounting hub 50b attached to the central axis 20, as illustrated in FIG. 3. Further, a hole 80 may be disposed in the middle of the midsleeve for receiving rod 53c extending from the rod mounting hub 50b. Preferably, the holes 76, 78, 80 are disposed through the solid section 74 and may provide structural reinforcement for the blade sections 18a, 18b.

Referring now to FIG. 8, the bottom end sleeve 44 is illustrated. The bottom end sleeve 44 operates as a rigid holder for the end of the blade section 38b, as illustrated in FIG. 3. The bottom end sleeve 44 includes a slot 82 disposed therein for receiving the end of the blade section 38b that is opposite the end of the blade section 38b that is disposed within the midsleeve 40. The bottom end sleeve 44 further includes a solid section 84 disposed on an edge of the bottom end sleeve 44 and running the length of the bottom end sleeve 44. Holes 86, 88 may be disposed on opposite ends of the bottom end sleeve 44 for receiving rods 55a, 55b that may extend from the rod mounting hub 50c connected to the central axis 20, as illustrated in FIGS. 3 and 4. The bottom end sleeve 44 and the rods 55a, 55b may work in concert to hold the blade section 38b of the blade 18a rigidly in place.

Referring now to FIG. 9, the top end sleeve 48 is illustrated. The top end sleeve 48 operates as a rigid holder for the end of the blade section 38a, as illustrated in FIGS. 3 and 4. The top end sleeve 48 includes a slot 92 disposed therein for receiving the end of the blade section 38a that is opposite the end of the blade section 38a that is disposed within the midsleeve 40. The top end sleeve 48 further may include a solid section 94 disposed on an edge of the top end sleeve 48 and running the length of the top end sleeve 48. Holes 96, 98 may be disposed on opposite edges of the top end sleeve 48 for receiving rods 52c, 52d extending from rod mounting hub 50a connected to the central axis 20, as illustrated in FIG. 3. The top end sleeve 44 and the rods 52c, 52d may work in concert to hold the blade section 38a of the blade 18a rigidly in place.

As illustrated in FIG. 2, a plurality of wind turbine sections 16a-16d may be connected in series to provide rotation of the central axis and, hence, generation of power using the electrical generator 36 and/or via electrical induction. The electricity generated therefrom may be utilized in any way apparent to one having ordinary skill in the art, such as to power devices that require electrical power. For example, the electricity generated may be fed into the utility grid thereby reducing or eliminating the cost of utilizing power from the utility grid, as apparent to one having ordinary skill in the art.

Referring now to FIG. 10, an alternate embodiment of a Savonius-type wind turbine apparatus 100 is provided. The wind turbine apparatus 100 may be a section of a larger wind turbine, having sections disposed in series with each other, or may constitute the entirety of the wind turbine. Generally, the wind turbine apparatus 100 may have blades 118a, 118b disposed in a modified Savonius curve to form a helical structure around a central axis. Moreover, the wind turbine apparatus 100 may further have airfoils 154a, 154b, 154c and 154d disposed thereon, as described above with reference to airfoils 54a-54d as shown and described with reference to FIGS. 3 and 4. In addition, the wind turbine apparatus 100 may further have a hood 134 for protecting elements disposed therein.

The wind turbine apparatus 100 may further include loops of magnets 102a, 102b and 102c disposed at spaced locations on the wind turbine apparatus. Generally, the loops of magnets 102a, 102b and 102c are disposed a radius away from the central axis. As shown in FIG. 10, the loops of magnets 102a, 102b and 102c are disposed on the airfoils 154a-154d to provide stability thereof. Further, blocks 104a, 104b and 104c may be disposed beneath the loops of magnets 102a-102c, the blocks 104a-104c having electrical induction pick-ups 106a, 106b and 106c respectively. Generally, as the loops of magnets 102a-102c rotate in close proximity to the pick-ups 106a-106c disposed on the blocks 104a-104c, respectively, electricity may be induced via magnetic flux. Although the wind turbine apparatus 100 shows three loops of magnets, any number of loops and pick-ups may be utilized to generate electricity, as apparent to one having ordinary skill in the art.

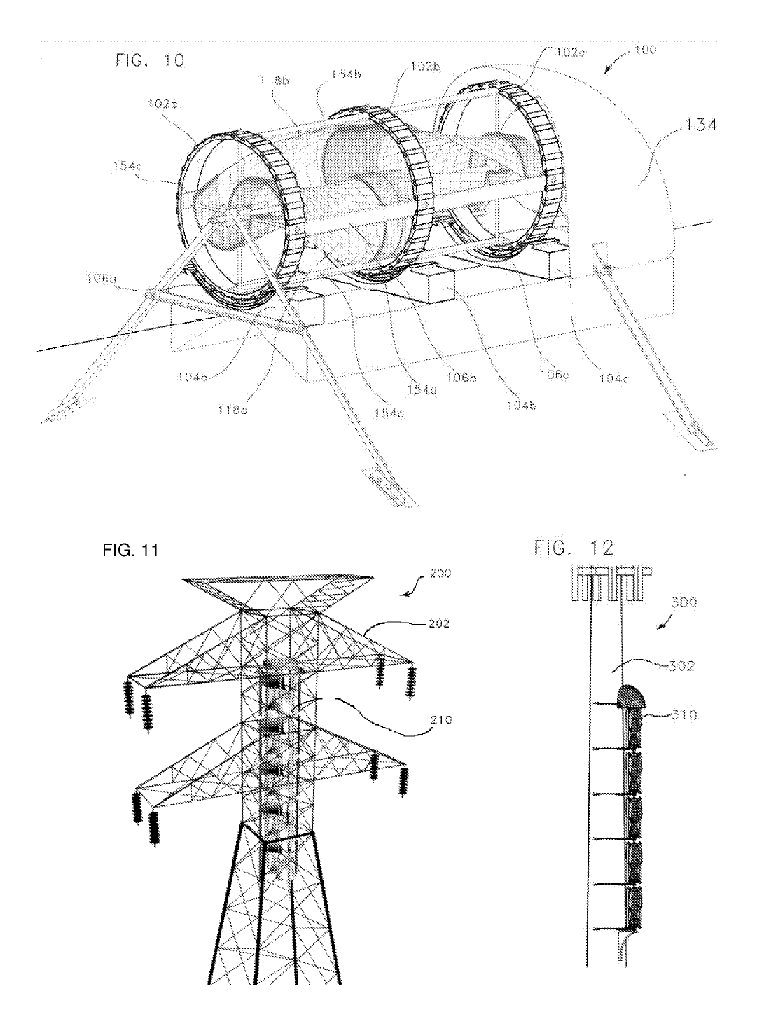

Referring now to FIG. 11, a system 200 is illustrated of a wind turbine apparatus 210 disposed vertically within a central shaft of a high tension wire structure 202. Therefore, it should be noted that the wind turbine apparatus of the present invention may be utilized within or on existing structures to provide electricity. In this case, electricity may be generated by the wind turbine apparatus 210 that may be fed directly into the utility grid, or may be stored to provide electricity when needed.

Referring now to FIG. 12, a system 300 is illustrated of a wind turbine apparatus 310 disposed vertically on a mounting leg of a cell phone tower 302. Specifically, the electricity generated may be used to power the cell phone tower 302 or may be stored for further use or for emergency purposes.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A wind turbine apparatus comprising:
a central axis running from a first end of the wind turbine apparatus to a second end of the wind turbine apparatus;
a pair of blades, each of the blades configured in a modified Savonius curve such that the two blades together form a helix around the pole;
a plurality of rods extending from the pole and connected to the pair of blades in spaced locations to rigidly connect the pair of blades to the pole;
a plurality of airfoils attached to distal ends of the rods; and
an electrical generator connected to the pole, whereby rotation of the central axis caused by wind pushing the pair of blades and the plurality of airfoils causes the generation of electricity.

2. The wind turbine apparatus of claim 1 wherein one of the pair of blades comprises two blade sections connected together.

3. The wind turbine apparatus of claim 2 wherein the two blade sections are connected together with a midsleeve, wherein the midsleeve comprises slots for receiving ends of the two blade sections.

4. The wind turbine apparatus of claim 3 wherein the midsleeve comprises at least one hole for receiving a first of the plurality of rods, wherein the first of the plurality of rods rigidly connects the midsleeve connecting the two blade sections to the pole at a distance from the pole.

5. The wind turbine apparatus of claim 2 wherein at least one of the blade sections comprises an end sleeve, wherein the end sleeve comprises a slot for receiving an end of the at least one blade section.

6. The wind turbine apparatus of claim 5 wherein the end sleeve comprises at least one hole for receiving a first of the plurality of rods, wherein the first of the plurality of rods rigidly connects the end sleeve to the pole at a distance from the pole.

7. The wind turbine apparatus of claim 1 further comprising:
a leg mounting hub on the pole, wherein the leg mounting hub comprises a bearing whereby the pole freely rotates within the bearing of the leg mounting hub; and
a leg attached to the leg mounting hub and further attached to a support structure, whereby the leg supports the wind turbine apparatus allowing the blades and plurality of airfoils to freely rotate when pushed by wind.

8. The wind turbine apparatus of claim 1 further comprising:
a rod mounting hub rigidly connected to the pole, wherein a first of the plurality of rods is rigidly connected to the rod mounting hub, wherein the first of the plurality of rods rigidly connects at least one of the pair of blades to the pole.

9. The wind turbine apparatus of claim 8 wherein the first of the plurality of rods is further connected at its distal end to one of the plurality of airfoils.

10. The wind turbine apparatus of claim 1 further comprising:
a first rod mounting hub rigidly connected to the pole, wherein a first of the plurality of rods is rigidly connected to the first rod mounting hub, wherein the first of the plurality of rods rigidly connects a first of the pair of blades to the pole; and
a second rod mounting hub rigidly connected to the pole, wherein a second of the plurality of rods is rigidly connected to the second rod mounting hub, wherein the second of the plurality of rods rigidly connects the first of the pair of blades to the pole.

11. A wind turbine system comprising:
a first wind turbine section comprising a first pole running from a first end of the first wind turbine section to a second end of the first wind turbine section and a first pair of blades, each of the blades in the first pair of blades configured in a Savonius curve such that the first pair of blades together form a double helix around the first pole, the first pole forming a central axis for the first wind turbine section, and the second pair of blades rigidly connected to the first pole;
a second wind turbine section comprising a second pole running from a first end of the second wind turbine section to a second end of the second wind turbine section and a second pair of blades, each of the second pair of blades configured in a Savonius curve such that the second pair of blades together form a double helix around the second pole, the second pole forming a central axis for the second wind turbine section, and the second pair of blades rigidly connected to the second pole, the second pole of the second wind turbine section connected to the first pole of the first wind turbine section; and
an electrical generator attached to at least one of the first pole or the second pole for generating electricity upon rotation of the first and second pairs of blades.

12. The wind turbine system of claim 11 wherein one of the first pair of blades comprises two blade sections connected together.

13. The wind turbine system of claim 12 wherein the two blade sections are connected together with a midsleeve, wherein the midsleeve comprises slots for receiving ends of the two blade sections.

14. The wind turbine system of claim 13 wherein the midsleeve comprises at least one hole for receiving at least one of the plurality of rods, wherein the at least one of the plurality of rods rigidly connects the midsleeve to the pole a distance from the pole.

15. The wind turbine system of claim 11 wherein at least one of the blade sections comprises an end sleeve, wherein the end sleeve comprises a slot for receiving an end of the at least one blade section.

16. The wind turbine system of claim 15 wherein the end sleeve comprises at least one hole for receiving at least one rod, wherein the at least one rod rigidly connects the end sleeve to the pole a distance from the pole.

17. The wind turbine system of claim 11 further comprising:
a leg mounting hub on the first pole, wherein the leg mounting hub comprises a bearing whereby the first pole freely rotates within the bearing of the leg mounting hub; and
at least one leg attached to the leg mounting hub and a support structure, whereby the at least one leg supports the wind turbine apparatus allowing the blades and plurality of airfoils to freely rotate when pushed by wind.

18. The wind turbine system of claim 11 further comprising:
a plurality of rods extending from the first pole and connected to the first pair of blades in spaced locations to rigidly connect the first pair of blades to the first pole;
a plurality of airfoils attached to distal ends of the rods.

19. The wind turbine system of claim 18 further comprising:
a rod mounting hub rigidly connected to the first pole, wherein a first of the plurality of rods is rigidly connected to the rod mounting hub, wherein the first of the plurality of rods rigidly connects a first blade of the first pair of blades to the pole.

20. The wind turbine system of claim 19 wherein the first of the plurality of rods is further connected at its distal end to a first of the plurality of airfoils.
